(19) United States
(12) Patent Application Publication
(10) Pub. No.: US 2011/0114487 A1
(43) Pub. Date: May 19, 2011

(54) APPARATUS, METHOD, AND GEL SYSTEM FOR ANALYTICAL AND PREPARATIVE ELECTROPHORESIS

(75) Inventors: Erwin Robert Schmidt, Ober-Olm (DE); Rudolf Baader, Mainz (DE)

(73) Assignee: JOHANNES GUTENBERG UNIVERSITÄT MAINZ, Mainz (DE)

(21) Appl. No.: 12/989,161

(22) PCT Filed: Apr. 20, 2009
(86) PCT No.: PCT/EP09/02852

§ 371 Date: Dec. 29, 2010

(30) Foreign Application Priority Data
Apr. 24, 2008 (DE) 10 2008 020 428.5

(51) Int. Cl. G01N 27/447

(52) U.S. Cl. 204/462; 204/606; 204/456

(57) ABSTRACT

The present invention relates to an electrophoresis apparatus comprising a gel chamber for receiving electrophoresis medium, a removable gel system, which is arranged in the gel chamber, having a separation gel for the electrophoretic separation of biological molecules such as nucleic acids or proteins, electric contact elements for generating an electric field through the separation gel, optionally a lid for fastening on the gel chamber, characterized in that the separation gel is delimited at least at one side by a spacer element which is in the form of a collector and comprises a plurality of sample collection containers, which are arranged one next to the other, for fractionating and for collecting the electrophoretically separated molecules. The invention further relates to a method for the electrophoretic separation and collection of biological molecules by way of a two-dimensional gel electrophoresis.

### TECHNICAL AREA

The present invention pertains to an electrophoresis apparatus and to a gel system for the analytical or preparative separation of biological molecules such as nucleic acids or proteins. The invention also pertains to a method for the isolation of biological molecules from an electrophoresis gel and to a method for the electrophoretic separation and collection of biological molecules by two-dimensional electrophoresis.

### PRIOR ART

Now as in the past, electrophoresis is still considered the best-performing method for the separation of biological molecules, especially nucleic acids (e.g., DNA, RNA) and proteins. An important area of application of electrophoresis is the analysis and preparation of DNA fragments or proteins. Primarily various types of agarose gels (for the separation of nucleic acids) or polyacrylamide gels (for the separation of proteins) are used in practice as the matrix of the separation gel.

In addition to the analytical separation of molecules, the electrophoresis method is also used for the preparation of DNA or proteins by gel extraction. In this case the molecules are labeled with special marker substances, so that their position in the gel becomes visible, possibly with the help of physical aids (e.g., UV light). For preparation, the part of the gel containing the molecules is cut out, and the desired molecules are isolated from the piece of gel. The method is quite complicated and requires a large number of reagents to perform it. During gel extraction, furthermore, the method often causes a considerable amount of the sample to be lost.

Two-dimensional gel electrophoresis (also called “2D gel electrophoresis”) is used for certain analyses. Through the combination of two electrophoresis steps conducted at right angles to each other, a high-resolution separation of the individual molecules is achieved. In most of the two-dimensional gel electrophoresis methods used today, the gel must be rotated after the first electrophoresis step so that the second electrophoresis step can be performed. An apparatus for two-dimensional electrophoresis is described in, for example, U.S. Pat. No. 5,041,203 and in US 2005/0040042 A1.

An apparatus for collecting biological molecules by means of a preparative electrophoresis apparatus is also described in DE 225 44 89 A1. The apparatus described here has a funnel-shaped zone for the electrophoresis gel, which tapers down at its bottom end to form a narrow opening, which is connected to an elution chamber. The elution chamber is provided with an outlet for the electrophoretically separated eluate. This apparatus is not suitable for two-dimensional electrophoresis. Because of the different migration rates of the molecules, furthermore, it is difficult to obtain precisely separated fractions.

### DESCRIPTION OF THE INVENTION

The goal of the present invention is to provide an electrophoresis apparatus by means of which analytical or preparative separation and isolation of biological molecules can be carried out quickly and efficiently without the use of gel extraction.

This goal is achieved by an electrophoresis apparatus according to claim 1 and by a method for electrophoretic separation and collection of biological molecules according to claim 9.

Preferred embodiments of the invention can be found in the subclaims.

Electrophoresis gels are usually cast between two glass plates, which are sealed off at the sides by two distance holders (spacers). These plate-gel systems are used especially for vertical gel electrophoresis processes. The thickness of the gel is defined in this case by the height of the spacers. Vertical gel electrophoresis makes it possible to achieve a much higher degree of separation of the molecular fractions than is possible with, for example, the horizontal gel electrophoresis often used for the separation of DNA fragments, in which the separation gel (now without plates) lies horizontally in the electrophoresis medium on a sled in the gel chamber. So that the samples can be applied in a chamber of this type, the samples must be mixed with a weighting agent (e.g., glycerin), so that the electrophoresis medium will not wash them out of the wells in the gel. In the case of protein gels, a collecting gel is often used in addition to the separation gel to concentrate the samples.

The present electrophoresis apparatus is characterized in that that a sample collector is used, which consists of one or more sample collection containers arranged next to each other and which forms the boundary of at least one side of the separation gel. The collector preferably has a strip-like shape and serves simultaneously as a spacer for the two glass plates of the gel system of a vertical electrophoresis apparatus. For the sake of simplicity, preferably two collectors of equal size are arranged between the glass plates on opposite sides like the conventional spacers. The individual sample collection containers of the collector serve to sort and collect the electrophoretically separated samples from the separation gel, in that the molecules are collected electrophoretically into the sample collection containers. The sample collection containers are preferably cylindrical or square.

The method for the electrophoretic separation and collection of biological molecules by means of two-dimensional gel electrophoresis, comprising the steps:

(a) performing a first electrophoresis step under application of an electric field in an electrophoresis medium-filled electrophoresis chamber with a gel system comprising at least one separation gel, as a result of which the molecules migrate through the separation gel as a function of their size,

(b) removing and rotating the gel system by 90°, and

(c) performing a second electrophoresis step under application of an electric field in the same or a different electrophoresis medium-filled electrophoresis chamber to collect the biological molecules separated as a function of size during the first electrophoresis step, wherein, for collection, a spacer designed as a collector is used, which forms the boundary of at least one side of the separation gel and comprises one or more sample collection containers arranged next to each other to collect the electrophoretically separated molecules.

The method is preferably carried out as follows: The bottom end of each individual sample collection container is first sealed with liquid gel material. For this purpose, the spacer is advisably placed in a dish containing liquid gel material, so that the liquid is drawn into the lumen of the individual sample collection container by the forces of cohesion. The gel material is allowed to set, which has the effect of sealing the bottom ends of the sample collection containers. The collector sealed in this way is then placed between the two plates to serve as a spacer, and the gel is cast between the glass plates in the usual manner.

After the gel has set, the gel system, consisting of the separation gel and the two glass plates, is placed in the electrophoresis chamber. Guide grooves are preferably formed for this purpose in the wall of the gel chamber; these grooves have a profile which makes it possible for the gel system to be inserted with a given orientation.

In the first electrophoresis step, the biological molecules are separated as a function of size. The invention is not limited to a certain type of biological molecule. The invention comprises all molecules which can be separated by gel electrophoresis, especially, however, nucleic acids such as DNA and RNA or proteins. The first electrophoresis step is continued until the molecules have been separated to the desired degree. The degree of separation can be monitored on the basis of markers conventionally used in this field.

Upon completion of the first electrophoresis step, the gel system is removed from the gel chamber and rotated by 90°, so that the collector with the sample collection containers is now at the bottom of the separation gel. By the application of a second electric voltage to produce a second electric field through the separation gel, the molecules which have been separated according to size in the separation gel by the first electrophoresis step are allowed to run into the individual sample collection containers of the collector and are collected there. The individual molecules have thus now been sorted according to their molecular size in the individual sample collection containers.

After the second electrophoresis step, the gel can be removed from the gel chamber, and the collected samples can be isolated (e.g., pipetted) from the individual sample collection containers. This process can also be automated. For the automated removal of the samples, a capillary is provided in a preferred embodiment; an ejection element is arranged in the hollow cylinder of the capillary. After the capillary has been dipped into the sample collection container of the spacer, the ejection element can be pushed out to remove the gel residues which are present after the dipping step and which could clog the capillary. With the help of a multi-pipette device, consisting of several capillaries, all of the sample collection containers of the collector can be treated in a single pipetting step, and the samples removed in this way can then be subjected to further processing for analysis or preparation. It is also possible to add chemical substances or to perform enzymatic reactions in the sample collection containers themselves. There is therefore no longer any need for a complicated extraction of the molecules from the gel, and the associated disadvantages are therefore eliminated. The inventive two-dimensional gel electrophoresis makes it possible to separate molecules with a high degree of resolution and easily to collect the molecular fractions.

The inventive collector is suitable for both horizontal and vertical electrophoresis apparatuses. The only essential point is that the molecules must be able to migrate through the separation gel under the effect of an electric field. In a first step, the molecules are separated as a function of size, and in the second step, the molecules separated in this way are collected in the sample collection containers of the collector. Thus the method is suitable for both analytical and preparative separations.

### SHORT DESCRIPTION OF THE DRAWINGS

The invention is explained in greater detail below on the basis of the following drawings:

FIGS. 1-3 show isometric diagrams of one embodiment of the inventive electrophoresis apparatus,

FIG. 4 shows a side view of a gel system with the two spacers, designed as collectors, with their sample collection containers,

FIG. 5 shows an isometric diagram of the gel system of FIG. 4,

FIG. 6 shows an embodiment of the floor of the gel chamber,

FIG. 7 shows an embodiment of a guide groove for the gel system, and

FIG. 8 shows another embodiment of the inventive electrophoresis chamber for the separation of proteins.

### WAYS OF EXECUTING THE INVENTION AND COMMERCIAL VIABILITY

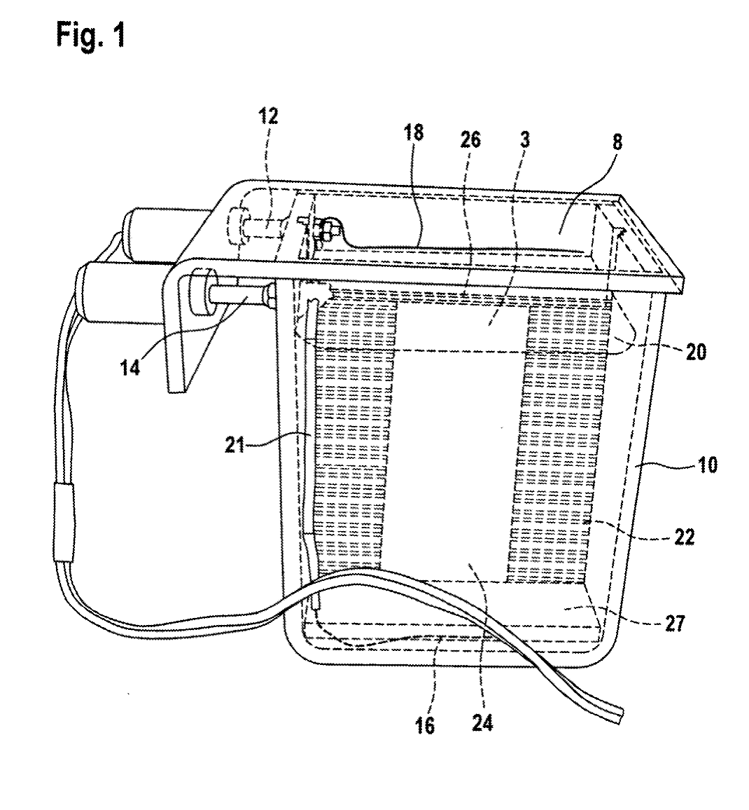

FIG. 1 shows a first embodiment of the inventive electrophoresis chamber. It is possible to see the gel chamber 10, into which the gel system, consisting of a separation gel 3, a glass plate as the front plate 24, and a glass plate as the rear plate 26, has been inserted. The individual sample collection containers 22, designed according to the invention as a collector, can be seen in the form of spacers, serving as lateral boundaries, which directly border the separation gel 3. To prepare it for operation, the gel chamber 10 is filled with electrophoresis medium 20 and covered for protection by a lid 8. The power is supplied via electrical terminals 12, 14. The electrical contact elements 16, 18 (conductor wires) for building up the electric field for electrophoresis are arranged in the two halves of the gel chamber 10. In the case of vertical electrophoresis, the positive contact wire (contact element 16) is located in the forward half of the chamber in the area of the floor 6. To prevent the molecules from migrating sideways during electrophoresis, the contact element 16 on the side is protected by an insulating tube 21. The contact element 18 is arranged in the rear half of the chamber at the top. As a result of the Z-shaped arrangement of the contact elements 16, 18, an oriented electric field is generated through the separation gel 3, as a result of which the molecules migrate through the separation gel 3 from top to bottom and are thus separated as a function of their size.

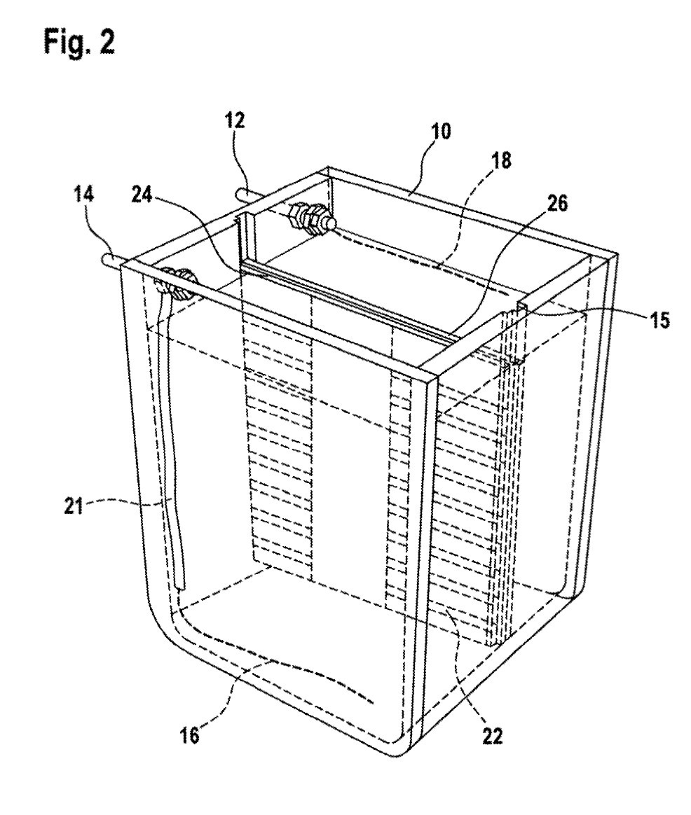

FIG. 2 shows an isometric diagram of the electrophoresis apparatus according to FIG. 1. After the completion of the first electrophoresis step, the gel system, consisting of the front plate 24, the rear plate 26, and the separation gel 3 located between them, is removed from the gel chamber and rotated by 90°, so that the sample collection containers 22 of the spacer are now at the bottom end of the separation gel 3. For the insertion of the gel system, a guide groove 15 is formed in the wall of the gel chamber 10. The guide grooves 15 separate the gel chamber 10 into two halves, in which the electric contact elements 16, 18 are arranged as described above.

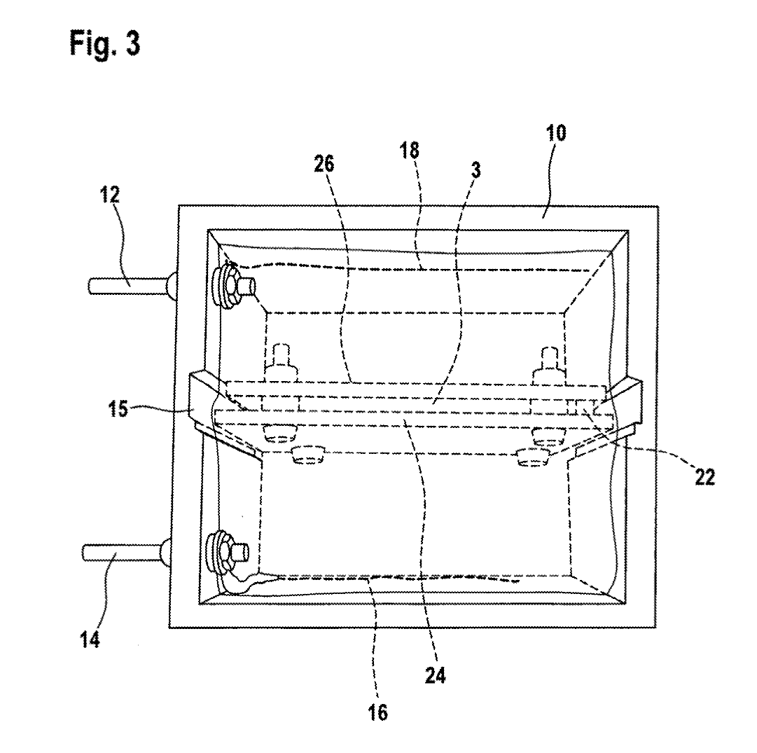

FIG. 3 shows a top view of the inventive electrophoresis apparatus. The gel system is inserted into the guide grooves 15 of the gel chamber 10.

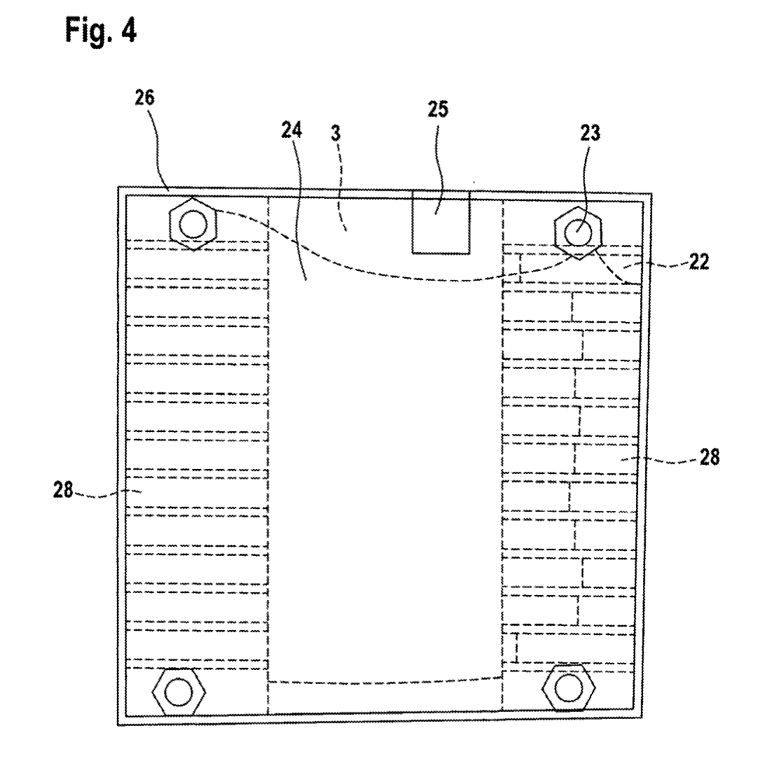

FIG. 4 shows the inventive gel system in greater detail. The system consists of the two glass plates 24, 26 with the separation gel 3 present between them. In the separation gel 3, a sample application well 25 for applying the sample can be seen. The two glass plates 24, 26 are held together by the connecting means 23. The collector with the sample collection containers 22 serves simultaneously as a spacer for the two glass plates 24, 26. The sample collection containers 22 are sealed off at their bottom end with gel material 28 to prevent molecules from diffusing out of the containers during the second electrophoresis step. Two spacers with sample collection containers 22 are preferably provided, which are arranged opposite each other and thus form the boundaries of the separation gel 3 on two sides.

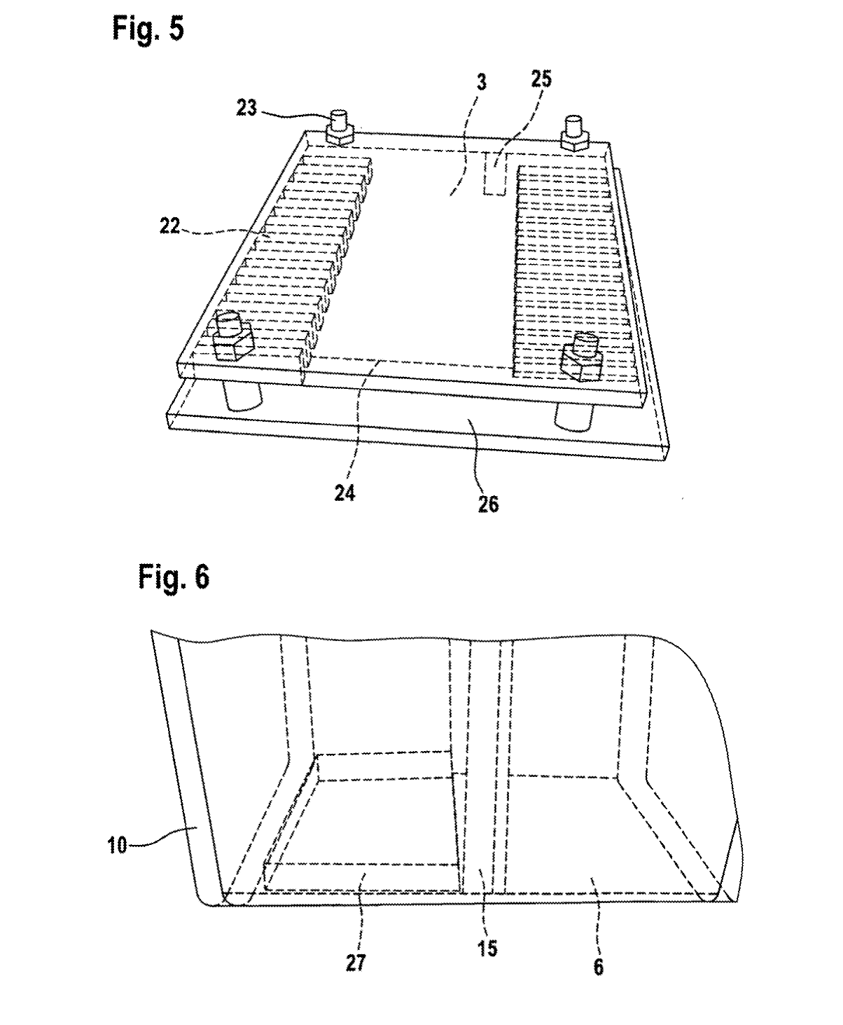

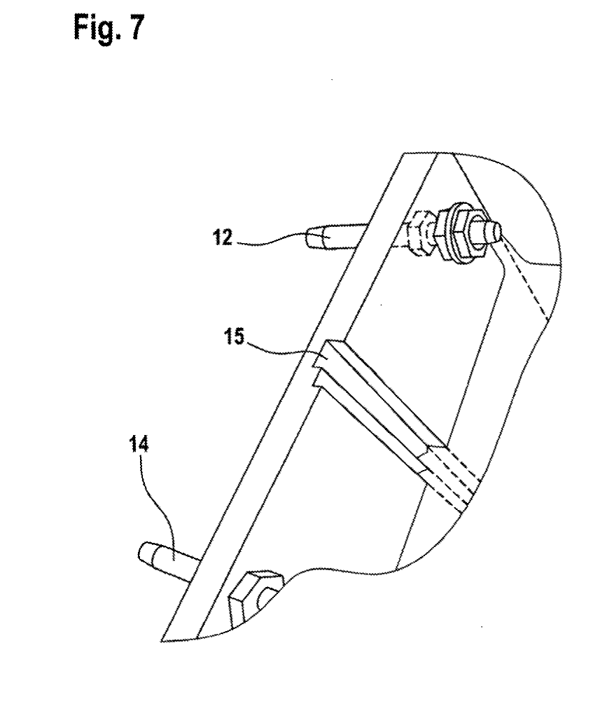

FIG. 5 shows a preferred variant of the inventive gel system, in which the front plate 24 comprises smaller dimensions than the rear plate 26. FIG. 6 shows how the glass plates 24, 26 are inserted as far as the chamber floor 6. Glass plates 24, 26 of different sizes have been found to be advantageous with respect to the generation of an oriented electric field through the separation gel 3. To prevent molecules from diffusing sideways out of the separation gel 3, a small retaining plate 27 is provided on the floor 6 of the chamber in the half with the smaller front plate 24; this retaining plate closes off the otherwise open area of the separation gel 3 extending along one side at the bottom.

FIG. 7 shows another preferred embodiment of the inventive electrophoresis apparatus. Depending on the gel system, it can be necessary to insert the two glass plates 24, 26 into the gel chamber 10 with a predefined orientation. The guide groove 15 is designed in such a way that, when the two glass plates 24, 26 are of different sizes, the desired orientation is achieved upon insertion of the gel system.

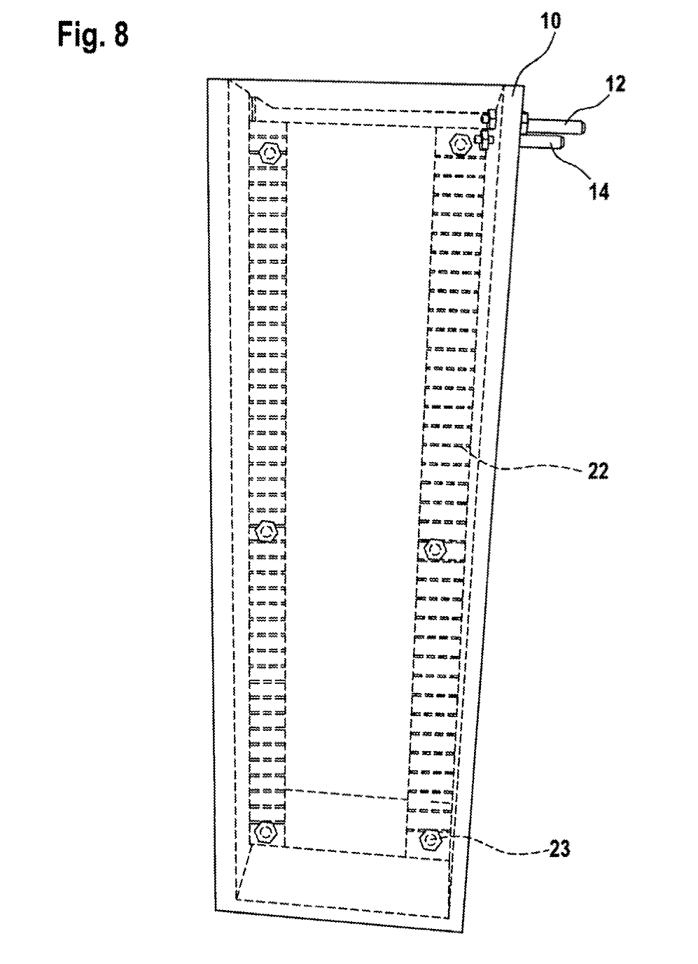

FIG. 8 shows another embodiment of the inventive electrophoresis apparatus. Here we have a chamber for the separation of proteins by SDS-PAGE. As a result of the vertical arrangement, the molecules are separated with a high degree of resolution. The separation principle is similar to that of the method previously described.

The inventive spacers with the sample collection containers 22 can be inserted into any conventional gel chamber. The only essential point is that an oriented current flow must take place through the separation gel 3. Additional embodiments of the inventive electrophoresis apparatus will be suggested to the person skilled in the art on the basis of the description of the present invention.

1. An electrophoresis device comprising:
a gel chamber to hold an electrophoresis medium,
a removable gel system arranged in the gel chamber with a separation gel for electrophoretic separation of biological molecules and
electrical contact elements for generating an electric field through the separation gel,
wherein the separation gel is bounded on at least one side by a spacer, said spacer comprising at least two sample collection containers arranged next to one another for sorting and collecting the electrophoretically separated biological molecules.

2. The electrophoresis device of claim 1, wherein the sample collection containers are cylindrical or square and are sealed off at the bottom with gel material.

3. The electrophoresis device of claim 1, wherein the gel system comprises two glass plates having a separation gel arranged between them, the gel being bounded laterally by two spacers with sample collection containers.

4. The electrophoresis device of claim 1, wherein the separation gel is arranged between a smaller front plate and a larger rear plate, and wherein the gel system is configured so that it can be inserted into the gel chamber with a predetermined orientation by means of a profiled guide groove formed in the gel chamber wall.

5. The electrophoresis device of claim 1, wherein the gel system is inserted vertically into the gel chamber and divides the gel chamber into two halves, and wherein an electrical contact element is arranged at the top of one of the halves of the gel chamber, and wherein the second electrical contact element is arranged at the bottom of the other half of the gel chamber.

6. The electrophoresis device of claim 1, wherein a small retaining plate, is arranged on the chamber floor in the half of the chamber with the smaller front plate and wherein said retaining plate is adapted to close off the separation gel along one side at the bottom.

7. The electrophoresis device of claim 1, wherein the gel system is arranged in the gel chamber either horizontally or vertically.

8. The electrophoresis device of claim 1, comprising a lid for attachment to the gel chamber.

9. A method for the electrophoretic separation and collection of biological molecules by means of two-dimensional gel electrophoresis, comprising the steps:
(a) performing a first electrophoresis step under application of an electric field in an electrophoresis medium-filled electrophoresis chamber with a gel system comprising at least one separation gel, as a result of which the biological molecules migrate through the separation gel as a function of their size,
(b) removing and rotating the gel system by 90°, and
(c) performing a second electrophoresis step under application of an electric field in the same or a different electrophoresis medium-filled electrophoresis chamber to collect the biological molecules separated as a function of size during the first electrophoresis step, wherein, for collection, a spacer forms the boundary of the separation gel on at least one side and comprises one or more sample collection containers arranged next to each other to collect the electrophoretically separated molecules.

10. The method of claim 9, wherein said method is carried out with an electrophoresis device comprising:
a gel chamber to hold an electrophoresis medium,
a removable gel system arranged in the gel chamber with a separation gel for electrophoretic separation of biological molecules and
electrical contact elements for generating an electric field through the separation gel,
wherein the separation gel is bounded on at least one side by a spacer, said spacer comprising at least two sample collection containers arranged next to one another for sorting and collecting the electrophoretically separated biological molecules.

11. A method for the electrophoretic separation and collection of biological molecules by means of two-dimensional gel electrophoresis carried out with the electrophoresis device of claim 1.

12. A gel system for carrying out preparative or analytical gel electrophoresis comprising:
a front plate,
a rear plate, and
a separation gel, which is arranged between the front plate and the rear plate and which is bounded on opposite sides by spacers,
wherein the separation gel is bounded on at least one side by a spacer, said spacer comprising at least two sample collection containers arranged next to one another for sorting and collecting the electrophoretically separated biological molecules.

13. A gel system according to claim 12, wherein the sample collection containers are sealed off at the bottom with gel material.

14. A method for isolating biological molecules comprising use of the gel system of claim 12.
